(19) United States
(12) Patent Application Publication
(10) Pub. No.: US 2025/0244963 A1
(43) Pub. Date: Jul. 31, 2025

(54) DYNAMICALLY GENERATING CODE FOR IMPLEMENTING A DESIGN COMPONENT IN A PRODUCTION ENVIRONMENT

(71) Applicant: Figma, Inc., San Francisco, CA (US)

(72) Inventors: Emil Sjölander, San Francisco, CA (US); Pau Tomás, San Francisco, CA (US); Karl Petersson, San Francisco, CA (US); Tom Duncalf, San Francisco, CA (US)

(21) Appl. No.: 18/750,948

(22) Filed: Jun. 21, 2024

Related U.S. Application Data
(60) Provisional application No. 63/626,526, filed on Jan. 29, 2024.

(51) Int. Cl. G06F 8/34

(52) U.S. Cl. CPC G06F 8/34

(57) ABSTRACT

A computing system detects a selection of a first design component when the first design component is rendered on a design interface as part of a graphic design, where the first design component being associated with a corresponding set of design component properties. The computing system determines code attribute values for the set of design component properties based on the set of rules. In response to detecting the user selection, the computing system dynamically generates a code signature or sample for implementing the first design component in a production environment based on the code attribute values that map to the set of design component properties of the first design component.

### RELATED APPLICATION(S)

This application claims benefit of priority to provisional application No. 63/626,526, filed Jan. 29, 2024; the aforementioned priority application being hereby incorporated by reference in its entirety.

### TECHNICAL FIELD

Examples described herein relate to a graphic design system, and more specifically to a system for dynamically generating code for implementing a design component in a production environment.

### BACKGROUND

Software design tools have many forms and applications. In the realm of application user interfaces, for example, software design tools require designers to blend functional aspects of a program with aesthetics and even legal requirements, resulting in a collection of pages which form the user interface of an application. For a given application, designers often have many objectives and requirements that are difficult to track.

Developers are often unfamiliar with the specifics of the graphic design, which in turn can be intricate and heavily detailed. The unfamiliarity can be a source of the inefficiency for developers, who often have to look carefully of the graphic design, view annotations from designers, and write code with the specifics in mind. Not only can the task of developers be efficient, the level of detail that is often included with the graphic design can make the developers task error-prone. For example, developers can readily miss read pixel distances between object, corner attribute, and other attributes which may be difficult to view without care.

### BRIEF DESCRIPTION OF THE DRAWINGS

FIG. 1A illustrates a graphic design implementation system, according to one or more embodiments.

FIG. 1B illustrates an example of the developer resource component 140, according to one or more embodiments.

FIG. 2A illustrates an example method for connecting a design component to a code representation, according to one or more embodiments.

FIG. 2B and FIG. 2C each illustrate an example method for dynamically generating a code set for implementing a design component in a production environment, according to one or more embodiments.

FIG. 3 illustrates an example design interface that includes a user-interface for displaying dynamically generated code for implementing a design component in a production environment, according to one or more embodiments.

FIG. 4 illustrates a computer system on which one or more embodiments can be implemented.

FIG. 5 illustrates a user computing device for use with one or more examples, as described.

### DETAILED DESCRIPTION

Examples include a computing system, computer-implemented method, and non-transitory computer-readable storage medium for implementing a graphic design interface that automates, or otherwise facilitates, the creation and association of production environment code and documentation with specific design elements of a graphic design.

The computing system implements operations to store a set of rules for mapping design component properties to code attribute values. The computing system detects a user selection of a first design component when the first design component is rendered on a design interface as part of a graphic design, where the first design component being associated with a corresponding set of design component properties. The computing system determines code attribute values for the set of design component properties based on the set of rules. In response to detecting the user selection, the computing system dynamically generates a code signature or sample for implementing the first design component in a production environment based on the code attribute values that map to the set of design component properties of the first design component.

In examples, the computing system displays the dynamically generated code signature or sample in a panel region while the first design component of the user selection is rendered on the design interface. For example, the panel region can be provided adjacent to the design interface. A user (e.g., developer) can, via the design interface, interact with a component of the graphic design, as rendered on the design interface, to trigger the creation of a code signature and/or sample for the component of the graphic design.

Additionally, in examples, if the same user, or another user (e.g., collaborative user) changes a property of the component, the computing system can automatically update the code signature and/or sample to reflect the change made to the component through the design interface.

In examples, the computing system stores a set of customized code snippets for components of a component library, where the components are reused by designers in connection with, for example, an enterprise account. The computing system dynamically generates the code signature or sample by integrating the code attribute values with the customized code snippet for the first design component.

In variations, the computing system filters the customized code snippet for the first design component based on the code attribute values that map to the set of design component properties of the first design component. In this way, when the signature and/or sample is displayed in a panel region provided with the design interface, the signature and/or sample is further configured to include code that is specifically tailored for the first design component.

Further, in examples, the user can interact with the panel region (or features provided there) to open a code editor and interact directly with at least a portion of a code base for implementing the first design component. A user/develop can, for example, generate additional or alternative samples to display in the panel region and/or use with the code base for implementing the graphic design in the production environment.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

### System Description

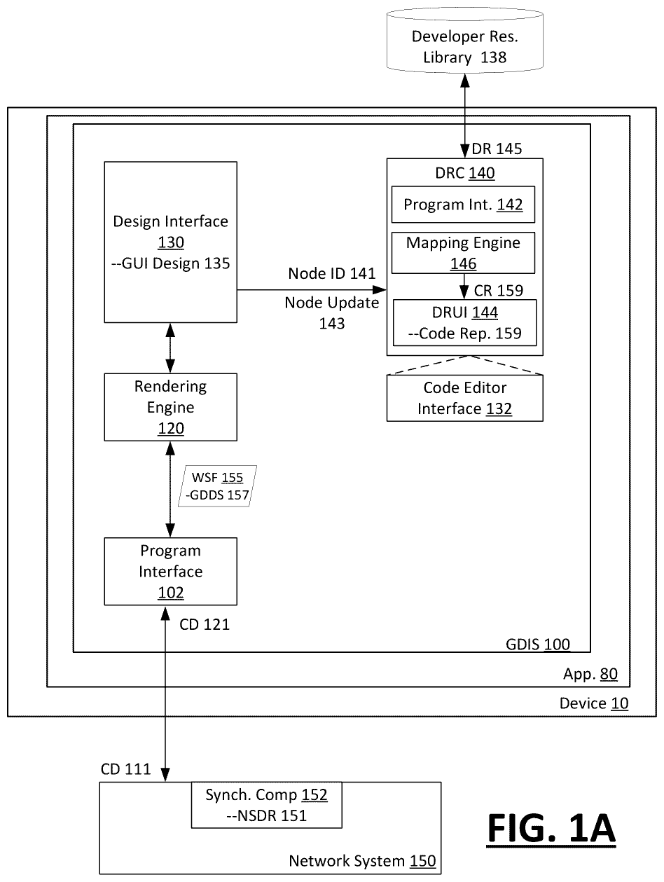

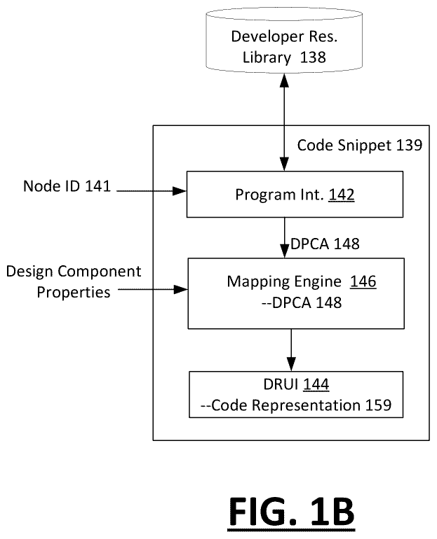

FIG. 1A illustrates a graphic design implementation system, according to one or more embodiments. A graphic design implementation system 100 (“GDIS 100”) as described with FIG. 1A can be implemented in any one of multiple different computing environments, including as a device-side application, as a network service, and/or as a collaborative platform. In examples, the GDIS 100 can be implemented using a web-based application 80 that executes on a user device 10. In other examples, the GDIS 100 can be implemented through use of a dedicated web-based application. As an addition or alternative, one or more components of the GDIS 100 can be implemented as distributed system, such that processes described with various examples execute on both a network computer (e.g., server) and on the user device 10.

In examples, the GDIS 100 includes processes that execute through a web-based application 80 that is installed on the computing device 10. The web-based application 80 can execute scripts, code and/or other logic to implement functionality of the GDIS 100. Additionally, in some variations, the GDIS 100 can be implemented as part of a network service, where web-based application 80 communicates with one or more remote computers (e.g., server used for a network service) to executes processes of the GDIS 100.

In examples, a user device 10 includes a web-based application 80 that loads processes and data for providing the GDIS 100 on a user device 10. The GDIS 100 can include a rendering engine 120 that enables users to create, edit and update graphic design files. Further, the GDIS 100 can include a code integration sub-system 180 to combine, or otherwise integrate programming code, data, assets and other logic for developing a graphic design as part of a production environment.

In some examples, web-based application 80 retrieves programmatic resources for implementing the GDIS 100 from a network site. As an addition or alternative, web-based application 80 can retrieve some or all of the programmatic resources from a local source (e.g., local memory residing with the computing device 10). The web-based application 80 may also access various types of data sets in providing functionality such as described with the GDIS 100. The data sets can correspond to files and libraries, which can be stored remotely (e.g., on a server, in association with an account) or locally.

According to examples, a user of device 10 operates web-based application 80 to access a network site, where programmatic resources are retrieved and executed to implement the GDIS 100. A user can initiate a session to implement the GDIS 100 to view, create and edit a graphic design, as well as to generate program code for implementing the graphic design in a production environment. In some examples, the user can correspond to a designer that creates, edits and refines the graphic design for subsequent use in a production environment.

In examples, the web-based application 80 can correspond to a commercially available browser, such as GOOGLE CHROME (developed by GOOGLE, INC.), SAFARI (developed by APPLE, INC.), and INTERNET EXPLORER (developed by the MICROSOFT CORPORATION). In such examples, the processes of the GDIS 100 can be implemented as scripts and/or other embedded code which web-based application 80 downloads from a network site. For example, the web-based application 80 can execute code that is embedded within a webpage to implement processes of the GDIS 100. The web-based application 80 can also execute the scripts to retrieve other scripts and programmatic resources (e.g., libraries) from the network site and/or other local or remote locations. By way of example, the web-based application 80 may execute JavaScript embedded in an HTML resource (e.g., web-page structured in accordance with HTML 5.0 or other versions, as provided under standards published by W3C or WHATWG consortiums). In other variations, the GDIS 100 can be implemented through use of a dedicated application, such as a web-based application.

The GDIS 100 can include processes represented by programmatic interface 102, rendering engine 120, design interface 130, code editor 132 and developer resource component 140. Depending on implementation, the components can execute on the user device 10, on a network system (e.g., server or combination of servers), or on the user device 10 and a network system (e.g., as a distributed process).

The programmatic interface 102 includes processes to receive and send data for implementing components of the GDIS 100. Additionally, the programmatic interface 102 can be used to retrieve, from local or remote sources, programmatic resources and a workspace file 155 of the user or user's account. In examples, the workspace file 155 includes one or more data sets (represented by “graphic design data set 157”) that represent a corresponding graphic design that can be rendered by rendering engine 120. The graphic design data set 157 can be structured as one or more hierarchical data structures. In some examples, the graphic design data set can be structured to define a graphic design as a collection of design elements, including objects, having a frame (or shape) and design attributes.

Further, in some examples, the graphic design data set 157 can be organized to include graphic designs on screens, where each graphic design including one or more pages (e.g., with one canvas per page), or sections that include one or multiple pages.

According to an aspect, the programmatic interface 102 also retrieves programmatic resources that include an application framework for implementing the design interface 130. The design interface 130 can utilize a combination of local, browser-based resources and/or network resources (e.g., application framework) provided through the programmatic interface 102 to generate interactive features and tools that can be integrated with a rendering of the graphic design on a canvas. The application framework can enable a user to view and edit aspects of the graphic designs. In this way, the design interface 130 can be implemented as a functional layer that is integrated with a canvas on which a graphic design is provided.

The design interface 130 can detect and interpret user input, based on, for example, the location of the input and/or the type of input. The location of the input can reference a canvas or screen location, such as for a tap, or start and/or end location of a continuous input. The types of input can correspond to, for example, one or more types of input that occur with respect to a canvas, or design elements that are rendered on a canvas. Such inputs can correlate to a canvas location or screen location, to select and manipulate design elements or portions thereof. Based on canvas or screen location, a user input can also be interpreted as input to select a design tool, such as may be provided through the application framework. In implementation, the design interface 130 can use a reference of a corresponding canvas to identify a screen location of a user input (e.g., ‘click’). Further, the design interface 130 can interpret an input action of the user based on the location of the detected input (e.g., whether the position of the input indicates selection of a tool, an object rendered on the canvas, or region of the canvas), the frequency of the detected input in a given time period (e.g., double-click), and/or the start and end position of an input or series of inputs (e.g., start and end position of a click and drag), as well as various other input types which the user can specify (e.g., right-click, screen-tap, etc.) through one or more input devices.

In some examples, the rendering engine 120 and/or other components utilize graphics processing unit (GPU) accelerated logic, such as provided through WebGL (Web Graphics Library) programs which execute Graphics Library Shader Language (GLSL) programs that execute on GPUs. In variations, the web-based application 80 can be implemented as a dedicated web-based application that is optimized for providing functionality as described with various examples. Further, the web-based application 80 can vary based on the type of user device, including the operating system used by the user device 10 and/or the form factor of the user device (e.g., desktop computer, tablet, mobile device, etc.).

The rendering engine 120 uses the graphic design data set to provide a corresponding graphic user-interface design 135 (“GUI design 135”) for the design interface 130. The GUI design 135 can include a combination of design elements that represent a functional user-interface for production-environment. In examples, a developer/user can view (and possibly edit) individual elements of the GUI design 135 to view customized code and resources for enabling the element to be properly presented in a production-environment. At the same time, design users can view and edit the GUI design 135 using the GDIS 100. Further, in examples, the GUI design 135 can represent multiple states of a functional user-interface or feature. By way of illustration, the GUI design 135 can include design elements that represent a soft-button feature of the production environment that can change states in response to events (e.g., receipt of notification) or user-interaction (e.g., input, hover, etc.). The change in state of the soft-button feature can correspond to, for example, the soft-button feature changing fill color, size or other visual attribute. With the GUI design 135, the soft-button feature can be represented by a “component” having multiple instances, variances, or alternative sets of properties associated with it. Accordingly, in examples, the GUI design 135 can includes graphic elements of different types, each of which can be associated with properties having property values. Each property of a graphic element can include a property type and a property value. For an object, the types of properties include, shape, dimension (or size), layer, type, color, line thickness, text size, text color, font, and/or other visual characteristics. Depending on implementation, the properties can reflect properties of two- or three-dimensional designs. In this way, property values of individual objects can define, for example, visual characteristics of size, color, positioning, layering, and content, for elements that are rendered as part of the design. Further, the GUI design 135 can include one or more components, each of which represent a reusable design element, or reusable set of design elements. In some examples, a component can be represented by a main component and instances of the main component, where the main component and each of the instances vary from one another by variation to one or more properties. In combination, the main component and the instances of the main component define a state of a corresponding graphic element in a run-time production environment. While examples are described in context of code, alternative examples can be implemented for other types of design elements, such as other types of reusable design elements. In some variations, a component can be defined at least in part by a set of component properties and property values, where the component properties and values are associated with the component to define, for example, different states or behaviors of a corresponding graphic element in the run-time production environment.

In some examples, the GDIS 100 enables components to be associated with one or more component property types. The component property types can include, for example, a Boolean property, a text property and a variant property. A Boolean property type can associate a graphic or design attribute of the component (or instance thereof) with a true/false value. Through the design interface 130, the user can toggle a Boolean property to turn a graphic attribute of the component on or off. A text property can indicate a layer of a component (or instance thereof) that can be modified with a text string, or have an existing text string modified. A variant property can define a set of design properties (e.g., size, shape, fill color, line color, etc.) for a variant (or component instance) of a component. Still further, in some examples, the component property types can include an instance swap property, which identify which variant (or instance component) can be swapped by a default value or instance from, for example, a library or collection. Other types of property components can be defined for use with a GUI design 135 via the GDIS 100.

The GDIS 100 can organize the GUI design 135 by cards, screens (e.g., representing a production environment display screen), pages (e.g., where each page includes a canvas on which a corresponding graphic design is rendered) and/or sections (e.g., where each screen includes multiple pages or screens). The user can interact with the design interface 130 to view and edit the GUI design 135. The design interface 130 can detect the user input, and the rendering engine 120 can update the GUI design 135 in response to the input. For example, the user can specify input to change a component of the GUI design 135, and in response, the rendering engine 120 updates the GUI design 135 to reflect the change to the component. Additionally, the rendering engine 120 can update the GUI design 135 of the graphic design, such that the user instantly sees the change to the GUI design 135 resulting from the user's interaction.

### Collaborative Environment

In examples, the GDIS 100 can be implemented as part of a collaborative platform, where a graphic design can be viewed and edited by multiple users operating different computing devices at locations. As part of a collaborative platform, when the user edits the GUI design 135, the changes made by the user are implemented in real-time to instances of the graphic design on the computer devices of other collaborating users. Likewise, when other collaborators make changes to the graphic design, the changes are reflected in real-time with the graphic design data set. The rendering engine 120 can update a local version of the GUI design 135 in real-time, to reflect changes to the GUI design 135 by the collaborators.

When the rendering engine 120 implements a change to the graphic design data set 157, change data 111 representing the change can be transmitted to the network system 150. The network system 150 can implement one or more synchronization processes (represented by synchronization component 152) maintain a network-side representation 151 of the graphic design. In response to receiving the change data 111 from the user device 10, the network system 150 updates the network-side representation 151 of the graphic design, and transmits change data 121 to the user devices of the other collaborators. Likewise, if another collaborator makes a change to their local instance of the GUI design 135, corresponding change data 111 can be communicated from that collaborator device to the network system 150. The synchronization component 152 updates the network-side representation 151 of the graphic design, and transmits corresponding change data 121 to the user device 10 to update the graphic design data set 157. The rendering engine 120 then updates the GUI design 135 to reflect the change from the collaborator device.

### Change Data

In examples, the GDIS 100 includes processes to record and/or detect changes to the graphic design data set 157. The change detection can track changes entered by, for example, a user of the computing device. As an addition or variation, the change detection can detect changes to graphic design data set 157 based on change data 121 received from the network system 150. The change detection can implement a set of changes to the GUI design 135 based on changes made by other collaborators.

Still further, the change detection can take snapshots at different instances of time, and generate a change data set to reflect a series of updates to the GUI design 135 (and graphic design data) over a given time period. For example, the change detection can compare snapshots of the graphic design data set between a time period when a user last edited or viewed the GUI design 135 (e.g., end of prior day) and a present time when the user starts a new session (e.g., current day) to edit or view the graphic design. When a user starts a new session, the network system 150 updates the graphic design data set with change data 111 that reflects updates to the graphic design from different collaborating users who may have worked on the workspace file 155 at different times.

In examples, the rendering engine 120 generates visual indicators of the change data set on the GUI design 135. The design interface 130 can implement the visual indicators as an additional layer, or with other functionality that allows a user to navigate across a design interface, such as from one point to another on a canvas, or from one page to another. The user can navigate from one point to the next by providing, for example, an input to view a “next” change, or a “previous” change. Based on the change data set, the design interface 130 can automatically locate points on the canvas or screen where design elements of the GUI design 135 have been changed (e.g., deleted, modified, added, etc.). Further, the rendering engine 120 can use the change data set to show visually what change occurred, such as by making a prior version of the portion of the design interface viewable.

### Code Generation

In examples, the GDIS 100 includes processes represented by developer resource component 140. The developer resource component 140 includes a program interface 142, a developer resource user-interface 144 and a mapping engine 146. The program interface 142 includes processes that communicate with a developer library 138 to retrieve developer resources 145. The developer resources 145 can include text-based representations of code and script, such as provided by a lower level representation in JavaScript. Alternatively, the developer resources may be provided as a JavaScript Object Notion (JSON) file, for implementing, in a production environment, the graphic design, and/or specific elements or aspects of the GUI design 135. Further, the developer resources 145 can include code that is customized for the user or an account of the user. In some examples, the developer resource component 140 displays the developer resources 145 in a developer resource user-interface 144. The user-interface interface 144 can include one or more panels or regions that are adjacent to or concurrently provided with the design interface 130. In this way, the user/developer can select a design element from the GUI design 135 and view at the same time relevant developer resources 145 for that element in the developer resource user-interface 144.

In examples, the developer resource component 140 associates a set of developer's resources 145 with specific design component(s) or other reusable design elements of a graphic design data set (e.g., design file). In this way, the developer's resource for a design component that is reused in different GUI designs 135 can also be reused. For example, a given account may store a component library, as well as a corresponding develop resources 145 for implementing individual components of the component library in a production environment. Among other benefits, by enabling reuse of developer's resources 145 with corresponding reusable components and elements, enterprises and other account holders can ensure consistent representation of design elements in code, as well as compliance by developers to guidelines and best-practices for representing design elements in a production-environment.

According to examples, a developer/user can select or otherwise interact with a component of the GUI design 135 through the design interface 130 to trigger the developer resource component 140 to generate or otherwise display a corresponding developer resource 145 for the component of the user's selection. On the design interface 130, the selected component can be represented by a node in a nodal representation of the GUI design 135. The node representing the selected component can include one or more identifiers (“node ID 141”), such as a node identifier and/or node attributes (e.g., text descriptor provider by a design user). In some examples, the program interface 142 uses the node identifiers 141 of the selected design component to retrieve and display corresponding developer's resources 145 for that element in the developer resource user-interface 144.

Further, in some examples, the mapping engine 146 dynamically generates one or more code representations 159 for a design component. In response to the user selecting a design component via the design interface 130, the mapping engine 146 dynamically generates one or more code representation 159 of the selected component based at least in part on design and component properties of the selected component, as well as customized developer resources that include code snippets or templates. Accordingly, in examples, the developer resource, and specifically program code that is displayed via the develop resource user-interface 144, is generated based on (i) a corresponding developer resource for the component that includes a program snippet or template customized for an account holder or user of the GDIS 100; (ii) design properties of the selected component; and/or (iii) one or more component properties of the selected component. In this way, the code provided with the developer resource user-interface 144 is dynamically generated, using a customized developer resource for that component (e.g., code snippet or template) and design and component properties of the selected design component. The dynamically generated code can be made a part of the codebase for the GUI design 135, such that execution of the code generates a corresponding production-environment feature that is consistent with other programmatic implements of the same component, and in accordance with requirements and/or guidelines of the account holder or user.

In some examples, a component rendered on the GUI design 135 can be updated by input by a user (e.g., designer), such that a design or component property of the component is changed (as represented by “node update 143” for a selected component). Alternatively, the change to the component can be by a different user collaborating on the GUI design 135 through use of a different computer. In response, the developer resource component 140 detects the change to the component, and automatically and dynamically updates the code representation for the selected component. The updated code representation can be displayed for the user in the developer resource user-interface 144.

The user (e.g., developer) can store, copy, edit or transfer program code displayed with the developer resource user-interface 144. The user may interact with the developer resource user-interface 144 to open a code editor 132, where the user can view, edit and/or perform operations such as copying/pasting or transferring the displayed program code into a codebase for implementing the GUI design 135. Further, the user can interact with the program code to generate an example (or additional example) of an implementation of the program code.

FIG. 1B illustrates an example of the developer resource component 140, according to one or more embodiments. The developer resource component 140 represent processes to dynamically generate customized code based on design and/or component properties of a selected component of a GUI design 135.

According to examples, the developer resource component 140 responds to a user (e.g., developer) providing input to select a component of a GUI design 135. In response to the user selection, the developer resource component 140 identifies the design and component properties of the selected component, based on, for example, attributes associated with the nodal element represented by the selected component. The developer resource component 140 can use one or more identifiers (e.g., node identifiers and descriptors, represented by “node ID 141”) of the selected component to retrieve, via the program interface 142, one or more customized code snippets 139 (or templates) from the developer resource library 138, where the customized code snippets 139 are associated with components with the same or similar identifier(s) as the selected component.

The mapping engine 146 includes design property/code attribute mapping logic (“DPCA”) 148 that maps properties of a design component to attribute values of a code representation for the design component. In examples, component properties can include a Boolean property (e.g., to toggle a feature of a component on or off), a text property (e.g., representing a layer of a component that can be modified with a text string), a variant property to define a set of design properties that vary for a variant (or component instance), and a swap property (e.g., to identify which variants of a component set can be swapped with other components). Other types of component properties may also be included. The DPCA mapping logic 148 can include, for example, rules and other logic that are developed to reflect objectives, guidelines, of practices of an account holder (e.g., enterprise) and/or user(s) of the GDIS 100. The developer resource component 140 can load the DPCA mapping logic 148 from the network system 150 and/or the developer resource library 138.

In response to a user selection of a component via the design interface, the developer resource component 140 identifies design and component properties of the selected design component. The developer resource component 140 uses one or more identifiers of the selected component to identify a set of customized snippets 149 from the developer resource library 138, where each snippet includes a portion of a signature or a portion of sample for the component. The developer resource component 140 uses the DPCA mapping logic 148 to map the identified design and component properties to attribute values of a code representation for the design component. Additionally, the developer resource component 140 integrates the code attribute values with customized snippets 149 to generate the signature or sample.

### Methodology

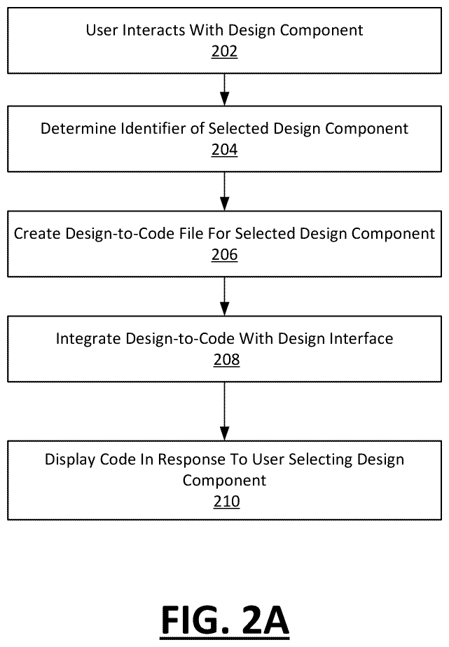

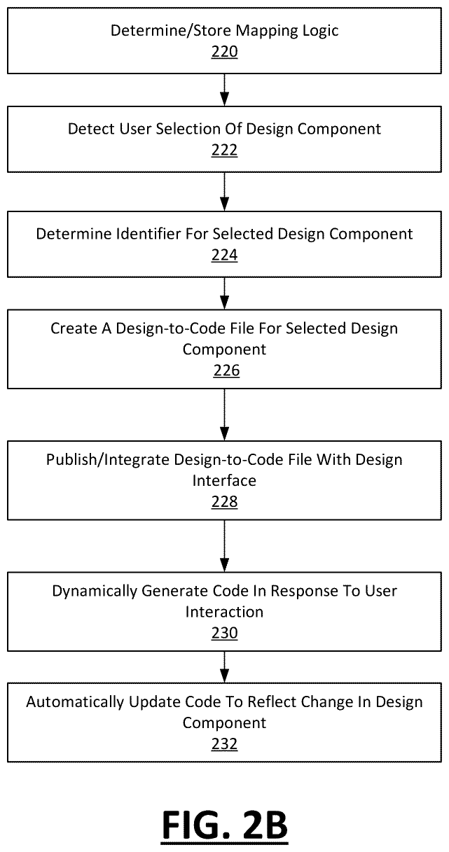

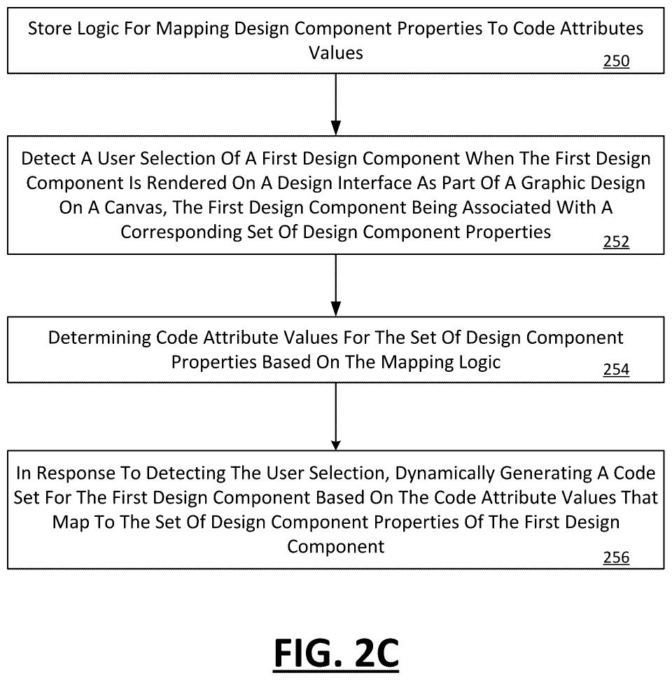

FIG. 2A illustrates an example method for connecting a design component to a code representation, according to one or more embodiments. FIG. 2B and FIG. 2C each illustrate an example method for dynamically generating a code set for implementing a design component in a production environment, according to one or more embodiments. In describing example methods of FIG. 2A through FIG. 2C, reference may be made to elements of FIG. 1A and FIG. 1B to illustrate functionality for performing a step or sub-step being described.

With reference to FIG. 2A, a user can interact with a component of a design interface to associate a design component with a set of code for implementing the design component in a production environment. In some variations, the code set can be predetermined so as to be customized for an account holder or user. In step 202, a user can select, via the design interface 130, a component of the GUI design 135. In step 204, the GDIS 100 determines an identifier of the component. For example, the user can generate a link for the component, where the link identifies a node representing the component. Alternatively, one or more identifiers can be determined from attributes of the node representing the selected design component. For example, the GDIS 100 can determine a selected component is a “button” based on a text attribute (e.g., label) or other attributes of the node representing the component on the design interface 130.

In step 206, a design-to-code file can be created for the selected design component, to link the design component to a code representation of the component. The file can logically link the selected design component with a set of code for implementing the component.

By way of illustration, in the case of a button component, the following pseudo-code can be represented of code included in the design-to-code file to link the design component with a set of code:

```
Designtocode [(
  designtocodefile:
    “https://local.linktodesigncomponent...”
  component: Button
  Examples: [Exampleusage]
  )]
```

In the example provided, the code representation for “button” is imported and logically linked to a reference or other identifier for the design component. Thus, the GDIS 100 can import code from, for example, an external resource (e.g., code library), based on the identifier or attributes of the node or design component. Further, the user can interact with the design-to-code file to modify or augment the contents of the file.

In step 208, the design-to-code file can be published or otherwise integrated with the design interface 130. For example, the design-to-code file can be converted into a Javascript template function, where the code representation provided with the design-to-code file can be compiled down to a lower level Javascript template function, where it can be executed in a sandbox environment of the GDIS 100. By utilizing a lower level JavaScript representation, the design-to-code file enables various types code representations to be utilized with the design-to-code file. In particular, code representations for any one of multiple different platforms (e.g., IOS, ANDROID, etc.), as well as code representations that enable or otherwise provide for extensibility by third parties that utilize custom code representations, can be compiled down to the same lower level JavaScript representation used with the design-to-code file.

Subsequently, when a user interacts with the design component via the design interface, the selection of the node causes the GDIS 100 to call, for example, a Javascript template function where the design component is linked to a corresponding set of code.

In step 210, the set of code that is included with the Javascript template function is displayed in the developer resource user-interface. In this way, the user (e.g., developer) can interact with the object to see a sample or signature set of code in, for example, a panel region accompanying the design interface.

As an addition or variation, the JavaScript template function containing the set of code for implementing the design component can be linked to other design components that share the same or similar attributes as the design component that was essentially selected. Thus, for example, the JavaScript template function can be provided for use with other GUI designs 135 that utilize a “button” component.

According to some examples of FIG. 2A, the code set for implementing a design component or type of design component (e.g., button) can be successively iterated or augmented by users. For example, users can view successive iterations of the code set for implementing the button code, or view examples that illustrate alternative implementations and use cases.

With reference to FIG. 2B, in step 220, logic for mapping design component properties to code attribute values (e.g., DPCA mapping logic 148) can be stored as a developer resource. The mapping logic can include a set of correlations and/or rules for mapping component properties (e.g., Boolean properties, variant properties, swap properties, text properties, etc.) to code attribute values. The mapping logic can be developed a user, or users that share developer resources (e.g., developer users of an account holder).

In step 222, a user can select, via the design interface 130, a component of the GUI design 135. In step 224, the GDIS 100 determines an identifier for the component. For example, the user can generate a link for the component, where the link identifies a node representing the component. Alternatively, one or more identifiers can be determined from attributes of the node representing the selected design component. According to some variations, in step 226, a design-to-code file can be created for the selected design component, to link the design component to a set of developer resources for the component. In such an example, the developer resources can include mapping logic (e.g., such as described with the DPCA mapping logic 148), customized snippets, and/or program code (e.g., samples). In step 228, the design-to-code file is published or otherwise integrated with the design interface 130, in conjunction with the design interface rendering a GUI design 135.

Subsequently, when a user interacts with the design component via the design interface, the selection of the node causes the GDIS 100 to call, for example, the JavaScript template function that is linked to the selected design component.

In step 230, the GDIS 100 uses the JavaScript template function to dynamically generate code for implementing the design component in a production environment. In examples, the GDIS 100 uses the mapping logic (or DPCA mapping logic 148) of the JavaScript template function to map design and component properties of the selected component to attribute values of a code representation for the design component. The attribute values can be integrated with customized code snippets to dynamically generate code set for implementing the design component. The code set can be customized to meet, for example, the objectives, guideline and practice of the user or account holder. For example, the code set can be formatted, structured, and/or integrated with values and code attributes that meet a preference or requirement of the user or account holder.

Subsequently, when the user or collaborator edits the design component, the dynamically generated code can be automatically updated to reflect the change in the design and/or component properties. The update to the code can be displayed in, for example, the developer resource user-interface 144. According to some aspects, updates to the code can be displayed in the developer resource user-interface 144 instantaneously, or nearly instantaneously, in response to changes made to the design component.

With reference to FIG. 2C, in step 210, a set of logic is stored for mapping design component properties to code attribute values. The logic can include rules, correlations, values and other data. The logic can be developed by users or through machine-learned processes.

In step 252, the GDIS 100 detects a user selection of a first design component when the first design component is rendered on a design interface as part of a canvas, where the first design component is associated with a corresponding set of design and component properties.

In step 254, the GDIS 100 determines, based on the mapping logic, code attribute values for the set of design and component properties of the design component.

In step 256, in response to detecting a user selection of a design component, a code set is dynamically generated for the first design component based on the code attribute values that map to the set of design component properties of the first design component. As described with other examples, the dynamically generated set of code can be displayed to the user (e.g., developer) alongside or with the rendered GUI design 135.

### Example Interfaces

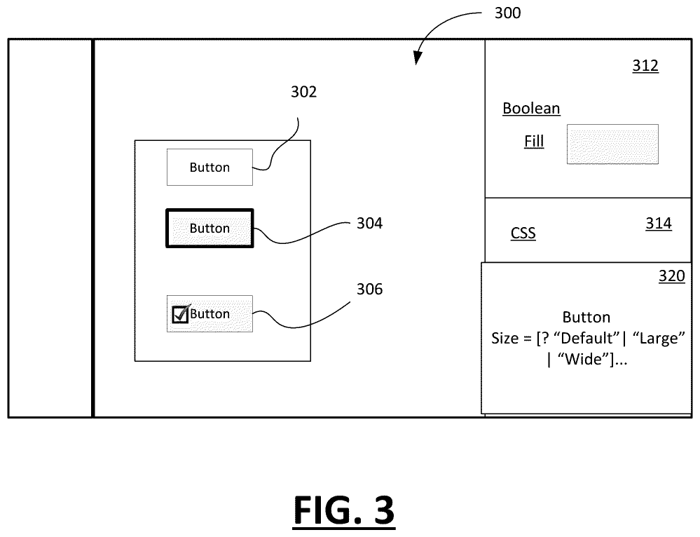

FIG. 3 illustrates an example design interface that includes a user-interface for displaying dynamically generated code for implementing a design component in a production environment, according to one or more examples. The design interface 300 can render a GUI design 300 (see also GUI design 135 of FIG. 1) that can be viewed and edited by designers or other users. A developer can access the design interface 300 to (i) view the GUI design 300; (ii) view design data (e.g., attributes, properties, names, etc.) for use with the code representation 145 (iii) inspect and/or edit portions of the code representation 145, particularly in context of corresponding portions of the GUI design 135; and/or (iv) write or generate code for implementing design elements that are rendered on a canvas as part of the GUI interface 300.

The GUI design 300 can include, for example, a component and its variants or instances (collectively “components”). The components can represent alternative states of a graphic user-interface feature in a production environment. In an implementation shown, components can vary in appearance by a limited number of design properties (e.g., fill color), with the variation in property values representing a particular state for the functional feature. The user can interact with individual components to view data and code for implementing each design component. When the design component 304 is selected, a design component property panel 312 can display component properties (e.g., Boolean property values) and design properties (e.g., fill color) for the component. The GUI design 300 can include a design property panel 314 where, for example, CSS data for the selected component is displayed. The GUI design 300 can also include a code panel 320, where dynamically generated code can be rendered in accordance with examples described. The code panel 320 provides an example of how the developer resource user-interface 144 (see FIG. 1A and FIG. 1B) can be implemented.

### Network Computer System

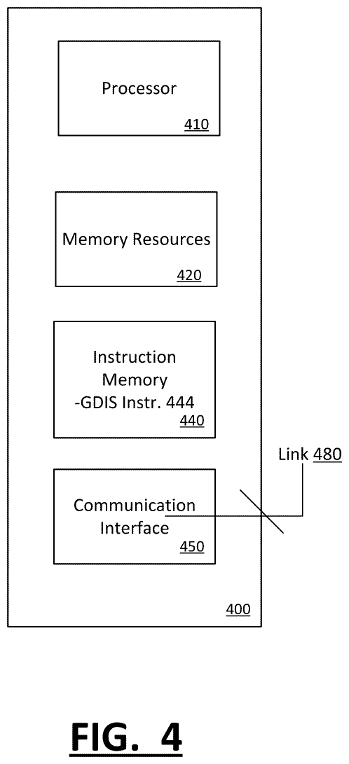

FIG. 4 illustrates a computer system on which one or more embodiments can be implemented. A computer system 400 can be implemented on, for example, a server or combination of servers. For example, the computer system 400 may be implemented as the GDIS 100 of FIG. 1A.

In one implementation, the computer system 400 includes processing resources 410, memory resources 420 (e.g., read-only memory (ROM) or random-access memory (RAM)), one or more instruction memory resources 440, and a communication interface 450. The computer system 400 includes at least one processor 410 for processing information stored with the memory resources 420, such as provided by a random-access memory (RAM) or other dynamic storage device, for storing information and instructions which are executable by the processor 410. The memory resources 420 may also be used to store temporary variables or other intermediate information during execution of instructions to be executed by the processor 410.

The communication interface 450 enables the computer system 400 to communicate with one or more user computing devices, over one or more networks (e.g., cellular network) through use of the network link 480 (wireless or a wire). Using the network link 480, the computer system 400 can communicate with one or more computing devices, specialized devices and modules, and/or one or more servers.

In examples, the processor 410 may execute service instructions 422, stored with the memory resources 420, in order to enable the network computing system to implement examples as described.

The computer system 400 may also include additional memory resources (“instruction memory 440”) for storing executable instruction sets (“GDIS instructions 444”) which are embedded with web-pages and other web resources, to enable user computing devices to implement functionality such as described with the GDIS 100.

As such, examples described herein are related to the use of the computer system 400 for implementing the techniques described herein. According to an aspect, techniques are performed by the computer system 400 in response to the processor 410 executing one or more sequences of one or more instructions contained in the memory 420. Such instructions may be read into the memory 420 from another machine-readable medium. Execution of the sequences of instructions contained in the memory 420 causes the processor 410 to perform the process steps described herein. In alternative implementations, hard-wired circuitry may be used in place of or in combination with software instructions to implement examples described herein. Thus, the examples described are not limited to any specific combination of hardware circuitry and software.

### User Computing Device

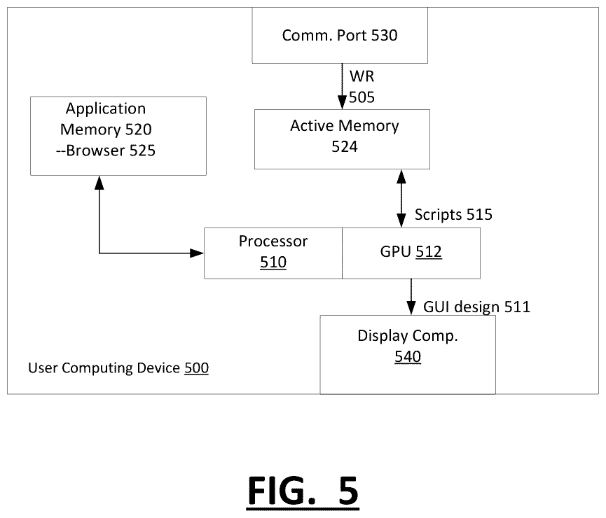

FIG. 5 illustrates a user computing device for use with one or more examples, as described. In examples, a user computing device 500 can correspond to, for example, a work-station, a desktop computer, a laptop or other computer system having graphics processing capabilities that are suitable for enabling renderings of design interfaces and graphic design work. In variations, the user computing device 500 can correspond to a mobile computing device, such as a smartphone, tablet computer, laptop computer, VR or AR headset device, and the like.

In examples, the computing device 500 includes a central or main processor 510, a graphics processing unit 512, memory resources 520, and one or more communication ports 530. The computing device 500 can use the main processor 510 and the memory resources 520 to store and launch a browser 525 or other web-based application. A user can operate the browser 525 to access a network site of the network service, using the communication port 530, where one or more web pages or other resources 505 for a network service can be downloaded. The web resources 505 can be stored in the active memory 524 (cache).

As described by various examples, the processor 510 can detect and execute scripts and other logic which are embedded in the web resource in order to implement the GDIS 100. In some of the examples, some of the scripts 515 which are embedded with the web resources 505 can include GPU accelerated logic that is executed directly by the GPU 512. The main processor 510 and the GPU can combine to render a GUI design 511 on a display component 540. The rendered design interface can include web content from the browser 525, as well as design interface content and functional elements generated by scripts and other logic embedded with the web resource 505. By including scripts 515 that are directly executable on the GPU 512, the logic embedded with the web resource 515 can better execute the GDIS 100, as described with various examples.

### CONCLUSION

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A computer-implemented method comprising:
storing a set of rules for mapping design component properties to code attribute values;
detecting a user selection of a first design component when the first design component is rendered on a design interface as part of a graphic design on a canvas, the first design component being associated with a corresponding set of design component properties;
determining code attribute values for the set of design component properties based on the set of rules; and
in response to detecting the user selection, dynamically generating a code signature or sample for implementing the first design component in a production environment based on the code attribute values that map to the set of design component properties of the first design component.

2. The computer-implemented method of claim 1, further comprising:
storing a set of customized code snippets for one or more design components, including the first design component;
wherein dynamically generating the code signature or sample includes integrating the code attribute values with the customized code snippet for the first design component.

3. The computer-implemented method of claim 2, wherein integrating the code attribute values with the customized code snippet for the first design component includes filtering the customized code snippet for the first design component based on the code attribute values that map to the set of design component properties of the first design component.

4. The computer-implemented method of claim 1, further comprising:
displaying the dynamically generated set of code in a panel while the first design component of the user selection is rendered on the design interface.

5. The computer-implemented method of claim 4, further comprising:
enabling user to interact with the panel to view the dynamically generated set of code in a code editor.

6. The computer-implemented method of claim 5, further comprising:
enabling the user to interact with the code editor to create an alternative set of code for implementing the first design component in the production environment; and
automatically displaying the alternative set of code with the panel.

7. The computer-implemented method of claim 1, further comprising:
detecting a change to the first design component based on a user input provided through the design interface;
automatically updating the code signature for the first design component based on a corresponding change to the design component properties.

8. The computer-implemented method of claim 1, wherein the design component properties include a Boolean property that determines whether a layer of the first design component is visible or not visible.

9. The computer-implemented method of claim 1, wherein the design component properties include a text property.

10. The computer-implemented method of claim 1, wherein the design component properties include a variant property that defines the first design component as a variant of another design component.

11. The computer-implemented method of claim 1, wherein the design component properties include an instance swap property.

12. A non-transitory computer-readable medium that stores instructions, which when executed by one or more processors of a computer system, cause the computer system to perform operations that include:
storing a set of rules for mapping design component properties to code attribute values;
detecting a user selection of a first design component when the first design component is rendered on a design interface as part of a graphic design on a canvas, the first design component being associated with a corresponding set of design component properties;
determining code attribute values for the set of design component properties based on the set of rules; and
in response to detecting the user selection, dynamically generating a code signature or sample for implementing the first design component in a production environment based on the code attribute values that map to the set of design component properties of the first design component.

13. The non-transitory computer-readable medium of claim 12, wherein the operations further comprise:
storing a set of customized code snippets for one or more design components, including the first design component;
wherein dynamically generating the code signature or sample includes integrating the code attribute values with the customized code snippet for the first design component.

14. The non-transitory computer-readable medium of claim 13, wherein integrating the code attribute values with the customized code snippet for the first design component includes filtering the customized code snippet for the first design component based on the code attribute values that map to the set of design component properties of the first design component.

15. The non-transitory computer-readable medium of claim 12, wherein the operations further comprise:
displaying the dynamically generated set of code in a panel while the first design component of the user selection is rendered on the design interface.

16. The non-transitory computer-readable medium of claim 15, wherein the operations further comprise:
enabling user to interact with the panel to view the dynamically generated set of code in a code editor.

17. The non-transitory computer-readable medium claim 16, further comprising:
enabling the user to interact with the code editor to create an alternative set of code for implementing the first design component in the production environment; and
automatically displaying the alternative set of code with the panel.

18. The non-transitory computer-readable medium of claim 12, further comprising:
detecting a change to the first design component based on a user input provided through the design interface;
automatically updating the code signature for the first design component based on a corresponding change to the design component properties.

19. The non-transitory computer-readable medium of claim 12, wherein the design component properties include a variant property that defines the first design component as a variant of another design component.

20. A computing system comprising:
one or more processors;
a memory storage resource that stores a set of instructions;
wherein the one or more processors execute the set of instructions to perform operations comprising: storing a set of rules for mapping design component properties to code attribute values;
detecting a user selection of a first design component when the first design component is rendered on a design interface as part of a graphic design on a canvas, the first design component being associated with a corresponding set of design component properties;
determining code attribute values for the set of design component properties based on the set of rules; and
in response to detecting the user selection, dynamically generating a code signature or sample for implementing the first design component in a production environment based on the code attribute values that map to the set of design component properties of the first design component.
